(19) United States
(12) Patent Application Publication
(10) Pub. No.: US 2019/0359363 A1
(43) Pub. Date: Nov. 28, 2019

(54) REUSABLE TAMPER-EVIDENT BAG

(71) Applicant: IPS Industries, Inc., Cerritos, CA (US)

(72) Inventors: Frank Su, Cerritos, CA (US); Song Ru Chua, Singapore (SG)

(21) Appl. No.: 15/770,941

(22) PCT Filed: Oct. 17, 2017
(86) PCT No.: PCT/US2017/057060

§ 371 Date: Apr. 25, 2018

(51) Int. Cl. B65B 61/14; B65D 33/34; B65D 30/18; B65D 33/02; B65D 33/10; B65D 33/16; B65D 33/20; B65D 75/58

(52) U.S. Cl. CPC B65B 61/14; B65D 33/34; B65D 31/08; B65D 33/02; B31B 2160/10; B65D 33/1691; B65D 33/20; B65D 75/5805; B65D 33/105

(57) ABSTRACT

In embodiments of the invention, a tamper-evident bag includes multiple side walls, a closed bottom, and an opening defined by a top edge of the multiple side walls. A handle feature is disposed on two side walls. A pressure-sensitive adhesive strip is disposed proximate to the top edge of a first side wall. A perforation line of uniform height is disposed in the multiple side walls above the handle feature and below the pressure-sensitive adhesive strip. Methods for using and manufacturing a reusable tamper-evident bag are also disclosed.

### BACKGROUND

### Field of Invention

The invention relates generally to bags. In particular, but not by way of limitation, embodiments of the invention provide a reusable tamper-evident bag, as well as methods for using and manufacturing such bags.

### Description of the Related Art

Drug stores, bakeries, restaurants, and other retailers may utilize in-house or 3rd-party services to deliver pharmaceuticals, foods, or other sensitive goods to consumers. One challenge such businesses face is how to maintain consumer confidence that the delivered product has not been tampered with during transport. Known delivery bags have many shortcomings. For instance, many bags do not include tamper-evident features. Moreover, known bags that are configured with a one-time seal have limited utility once the bag is opened. New innovations are needed in this underserved market space.

### SUMMARY OF THE INVENTION

In embodiments of the invention, a tamper-evident bag includes multiple side walls, a closed bottom, and an opening defined by a top edge of the multiple side walls. A handle feature is disposed on two side walls. A pressure-sensitive adhesive strip is disposed proximate to the top edge of a first side wall. A perforation line of uniform height is disposed in the multiple side walls above the handle feature and below the pressure-sensitive adhesive strip. Methods for using and manufacturing a reusable tamper-evident bag are also disclosed. Various alternative embodiments and advantages will be described below.

### BRIEF DESCRIPTION OF THE DRAWINGS

FIG. 1A is a side view of a bag according to a first embodiment of the invention;

FIG. 1B is a sectional view of a bag according to the first embodiment of the invention;

FIG. 1C is a sectional view of a bag according to a variation of the first embodiment of the invention;

FIG. 2A is a side view of a bag according to a second embodiment of the invention;

FIG. 2B is a sectional view of a bag according to the second embodiment of the invention;

FIG. 2C is a sectional view of a bag according to a variation of the second embodiment of the invention;

FIG. 3A is a side view of a bag according to a third embodiment of the invention;

FIG. 3B is a sectional view of a bag according to the third embodiment of the invention;

FIG. 3C is a sectional view of a bag according to a variation of the third embodiment of the invention;

FIG. 4A is a side view of a bag according to a fourth embodiment of the invention;

FIG. 4B is a sectional view of a bag according to the fourth embodiment of the invention;

FIG. 4C is a sectional view of a bag according to a variation of the fourth embodiment of the invention;

FIG. 5 is a flow diagram of a method for using a reusable tamper-evident bag, according to an embodiment of the invention;

FIG. 6 is a flow diagram of a method for manufacturing a reusable tamper-evident bag, according to an embodiment of the invention; and

FIG. 7 is a flow diagram of a method for manufacturing a reusable tamper-evident bag, according to an embodiment of the invention.

### DETAILED DESCRIPTION

Embodiments of the invention are described below with reference to the drawings. Such embodiments are meant to be illustrative and not restrictive. The drawings are not to scale. Certain features illustrated in the drawings may be exaggerated in size, and other features may be omitted altogether, for clarity. Section titles are used below for organizational convenience; but the description of any feature is not necessarily limited to any section of this specification.

The following paragraphs describe four alternative bag configurations, each having at least one possible variation. This specification also describes how to use such a bag, as well as methods for their manufacture.

### Alternative Bag Structures

The bags described herein could be constructed from various flexible materials, or from a combination of materials, according to application needs. For instance, the bags could be or include plastics, such as polyethylene (PE) or polypropylene (PP). For some applications, the bags could be constructed partially, or completely, from paper.

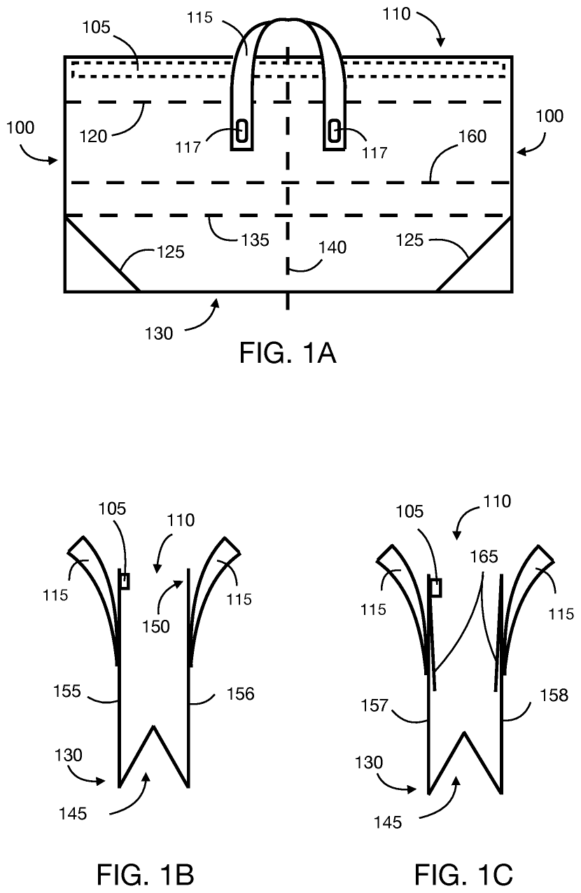

FIG. 1A is a side view of a bag according to a first embodiment of the invention. FIG. 1B is a sectional view of that same embodiment at cutting line 140. As shown therein, a bag includes a pressure-sensitive adhesive strip 105 disposed on an inner portion of side wall 155 near bag opening 110. The pressure-sensitive adhesive strip 105 preferably includes a release liner (not shown) to prevent adhesion when not intended. In use, the release liner is removed and the bag opening 110 is sealed closed by forming a bond between the pressure-sensitive adhesive strip 105 and an inside surface 150 of opposing wall 156. The pressure-sensitive adhesive strip 105 has a relatively high level of adhesion such that any attempt to breach the seal formed by pressure-sensitive adhesive strip 105 would be evident. As used herein, a pressure-sensitive adhesive strip refers to a strip containing a permanent adhesive.

Soft loop handles 115 may be, for example, strips of pliable plastic. The soft loop handles 115 are disposed on exterior surfaces of sidewalls 155, 156, and attached at weld areas 117. In conventional bags, handles are bonded to interior surfaces. Welding to exterior surfaces, as shown in FIGS. 1A and 1B, is beneficial because doing so avoids interference with the pressure-sensitive adhesive strip 105.

A perforation line 120 facilitates consumer access to bag contents after the bag opening 110 has been permanently sealed by activation of the pressure-sensitive adhesive strip 105. As illustrated in FIG. 1A, a perforation line 120 is disposed above the weld areas 117 and below the pressure-sensitive adhesive strip 105. A new bag opening is formed at perforation line 120 upon separating the bag at perforation line 120. Advantageously, such separation leaves the handles 115 intact, increasing utility of the bag for post-delivery uses (i.e., reuses).

The bag also preferably includes a gusset 145 formed between a bottom edge 130 and a gusset fold 135. The gusset 145 enables a substantially flat-bottom for bag contents. Optional corner welds 125 enhance strength at ends of the gusset 145.

FIG. 1C is a sectional view of a bag according to a variation of the first embodiment of the invention. In the illustrated variation, side walls 155 and 156 are replaced with side walls 157 and 158, respectively. The difference is that sidewalls 157 and 158 include folded-over portions 165. This provides a folded edge at bag opening 110, and a 2-ply thickness in portions of each sidewall 157, 158, to include welds areas 117. In the illustrated embodiment, folded-over portions 165 are joined to sidewalls 157 and 158 at weld line 160.

Variations to the embodiments illustrated in FIGS. 1A, 1B, and 1C and described above are possible. For example, the handles 115 could be formed from alternative materials or presented in alternative shapes, so long as they are attached to an exterior surface of the sidewalls below the perforation line 120. In the case of paper construction, the weld areas 117 could instead be glue areas 117, optional corner welds 125 could instead be optional corner glue lines 125, and the weld line 160 could instead be a glue line 160. In some applications, the gusset 145 may not be required. In the illustrated embodiment, sidewalls 155 and 156 (the variant in FIG. 1B), or 157 and 158 (the variant in FIG. 1C), are joined at edges 100. But other features described above can readily apply to a 4-sided bag.

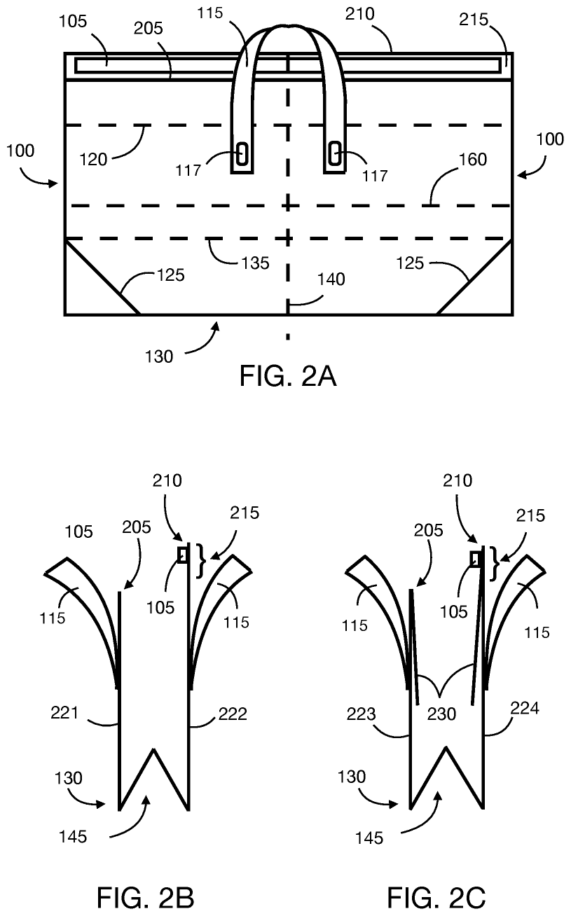

FIG. 2A is a side view of a bag according to a second embodiment of the invention; FIG. 2B is a sectional view of that same embodiment at cutting line 140. The second embodiment includes identical features as the first embodiment, except as described below.

As illustrated in FIGS. 2A and 2B, sidewall 221 has a top edge 205, and sidewall 222 has a top edge 210. Sidewall 222 is taller than sidewall 221, creating a flap 215. The pressure-sensitive adhesive strip 105 is disposed on an interior surface of the flap 215. In use, the release liner is removed from the pressure-sensitive adhesive strip 105, the flap 215 is folded over the top edge 205, and the pressure-sensitive adhesive strip 105 is bonded to an exterior surface of the sidewall 221.

FIG. 2C is a sectional view of a bag according to a variation of the second embodiment of the invention. In the illustrated variation, side walls 221 and 222 are replaced with side walls 223 and 224, respectively. The difference is that sidewalls 223 and 224 include folded-over portions 230. This provides a folded edge at bag opening top edges 205 and 210, and a 2-ply thickness in portions of sidewalls 223, 224, to include weld areas 117. In the illustrated embodiment, folded-over portions 230 are joined to sidewalls 223 and 224 at weld line 160.

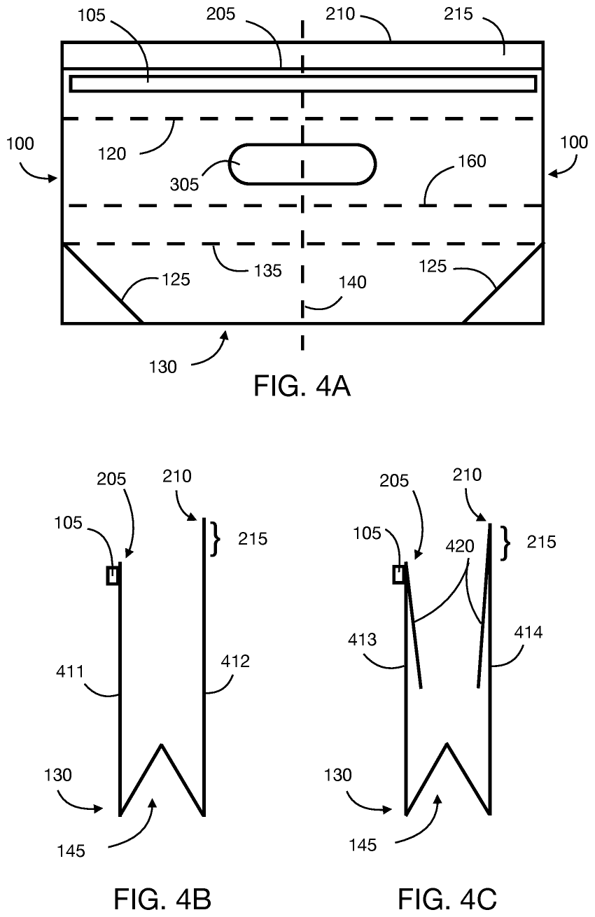

Variations to the embodiments illustrated in FIGS. 2A, 2B, and 2C and described above are possible. For example, the handles 115 could be formed from alternative materials or presented in alternative shapes, so long as they are attached to an exterior surface of the sidewalls below the perforation line 120. In the case of paper construction, the weld areas 117 could instead be glue areas 117, optional corner welds 125 could instead be optional corner glue lines 125, and the weld line 160 could instead be a glue line 160. Moreover, in some applications, the gusset 145 may not be required. In addition, in an alternative embodiment, the pressure-sensitive adhesive strip 105 could be disposed on an exterior surface of sidewall 221 or 223 adjacent to top edge 205 rather than on the flap 215 (as illustrated in FIGS. 4A, 4B, and 4C). In the illustrated embodiment, sidewalls 221 and 222 (the variant in FIG. 2B), or 223 and 224 (the variant in FIG. 2C), are joined at edges 100. But other features described above can readily apply to a 4-sided bag.

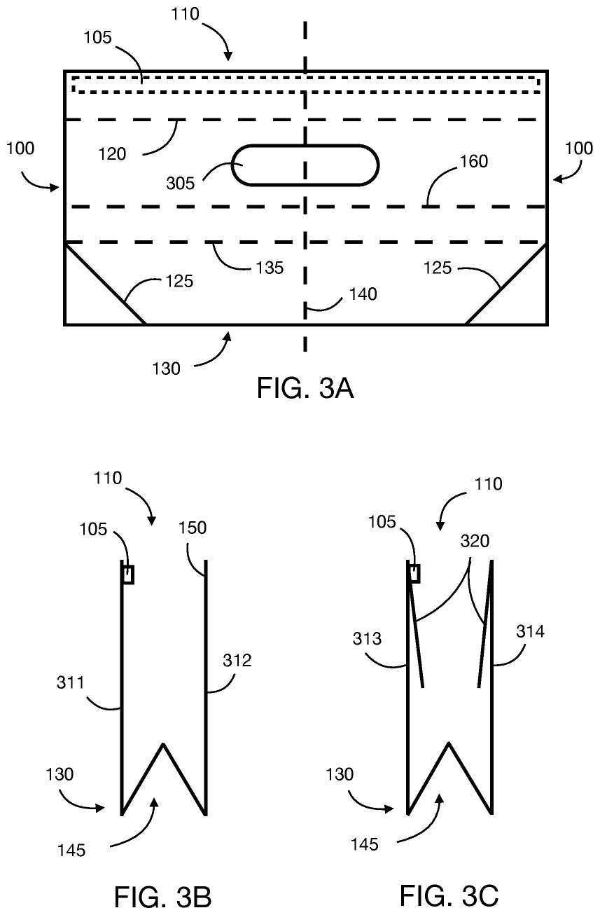

FIG. 3A is a side view of a bag according to a third embodiment of the invention; FIG. 3B is a sectional view of that same embodiment at cutting line 140. The third embodiment includes identical features as the first embodiment, except as described below.

As illustrated in FIGS. 3A and 3B, a die cut handle 305 is disposed in sidewalls 311 and 312 below perforation line 120. In the variation illustrated in FIG. 3C, side walls 311 and 312 are replaced with side walls 313 and 314, respectively. The difference is that sidewalls 313 and 314 include folded-over portions 320. This provides a folded edge at bag opening 110, and a 2-ply thickness in portions of sidewalls 313, 314, to include the portion surrounding die cut handle 305. In the illustrated embodiment, folded-over portions 320 are joined to sidewalls 313 and 314 at weld line 160.

Variations to the embodiments illustrated in FIGS. 3A, 3B, and 3C and described above are possible. For example, die cut handles 305 could be shaped differently, so long as they are disposed below the perforation line 120. In the case of paper construction, optional corner welds 125 could instead be optional corner glue lines 125, and the weld line 160 could instead be a glue line 160. Moreover, in some applications, the gusset 145 may not be required. In the illustrated embodiment, sidewalls 311 and 312 (the variant in FIG. 3B), or 313 and 314 (the variant in FIG. 3C), are joined at edges 100. But other features described above can readily apply to a 4-sided bag.

FIG. 4A is a side view of a bag according to a fourth embodiment of the invention; FIG. 4B is a sectional view of that same embodiment at cutting line 140. The fourth embodiment includes identical features as the second embodiment, except as described below.

As illustrated in FIGS. 4A and 4B, a die cut handle 305 is disposed in sidewalls 411 and 412 below perforation line 120. In addition, the pressure-sensitive adhesive strip 105 is disposed on an exterior surface of sidewall 105 adjacent to top edge 205. In the variation illustrated in FIG. 4C, side walls 411 and 412 are replaced with side walls 413 and 414, respectively. The difference is that sidewalls 413 and 414 include folded-over portions 420. This provides a folded edge at top edges 205 and 210, and a 2-ply thickness in portions of sidewalls 413, 414, to include the portion surrounding die cut handle 305. In the illustrated embodiment, folded-over portions 420 are joined to sidewalls 413 and 414 at weld line 160.

Variations to the embodiments illustrated in FIGS. 4A, 4B, and 4C and described above are possible. For example, die cut handles 305 could be shaped differently, so long as they are disposed below the perforation line 120. In the case of paper construction, optional corner welds 125 could instead be optional corner glue lines 125, and the weld line 160 could instead be a glue line 160. Moreover, in some applications, the gusset 145 may not be required. In addition, in an alternative embodiment, the pressure-sensitive adhesive strip 105 could be disposed on an interior surface of the flap 215 rather than on an exterior surface of sidewall 411 or 413 adjacent to top edge 205 (as illustrated in FIGS. 2A, 2B, and 2C). In the illustrated embodiment, sidewalls 411 and 412 (the variant in FIG. 4B), or 413 and 414 (the variant in FIG. 4C), are joined at edges 100. But other features described above can readily apply to a 4-sided bag.

### Method for Using

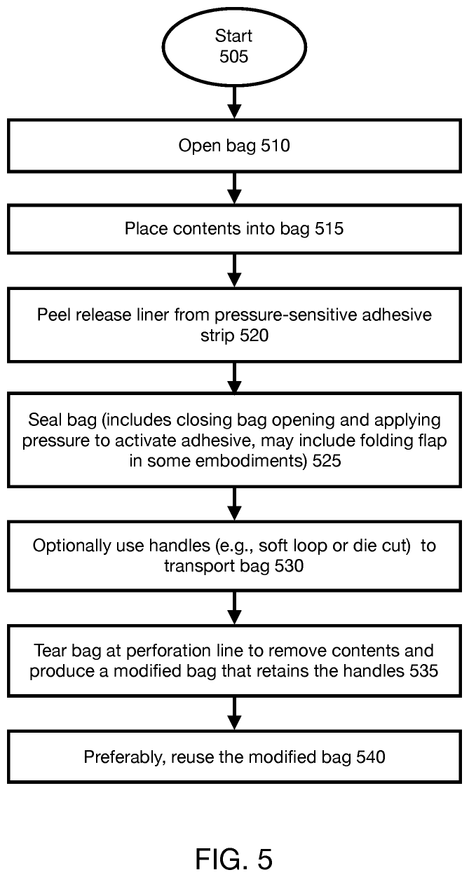

FIG. 5 is a flow diagram of a method for using a reusable tamper-evident bag, according to an embodiment of the invention. As shown therein, a process starts in step 505. A first user, for instance a retailer, opens the bag in step 510, places contents into the bag in step 515, peels a release liner from the pressure-sensitive adhesive strip 105 in step 520, and seals the bag in step 525. Step 525 may include closing the bag and applying pressure to activate the permanent adhesive. In bag embodiments having a flap 215, for instance as described with reference to FIGS. 2A, 2B, 2C, 4A, 4B, and 4C, step 525 may include folding the flap 215 prior to sealing.

A second user optionally uses handles (e.g. soft loop handles 115 or die cut handles 305) to transport the bag to a third user in step 530. The third user tears the bag at perforation line 120 to remove the contents and produce a modified bag that retains the handles in step 535. Preferably, the third user (or perhaps a fourth user) reuses the modified bag in step 540. Step 540 is facilitated by the fact that handles (e.g., soft loop handles 115 or die cut handles 305) are intact on the bag after perforation line 120 has been torn.

Variations in the process illustrated in FIG. 5 and described above are possible. For example, in alternative embodiments, a different number of users could be associated with the above method.

### Methods for Manufacturing

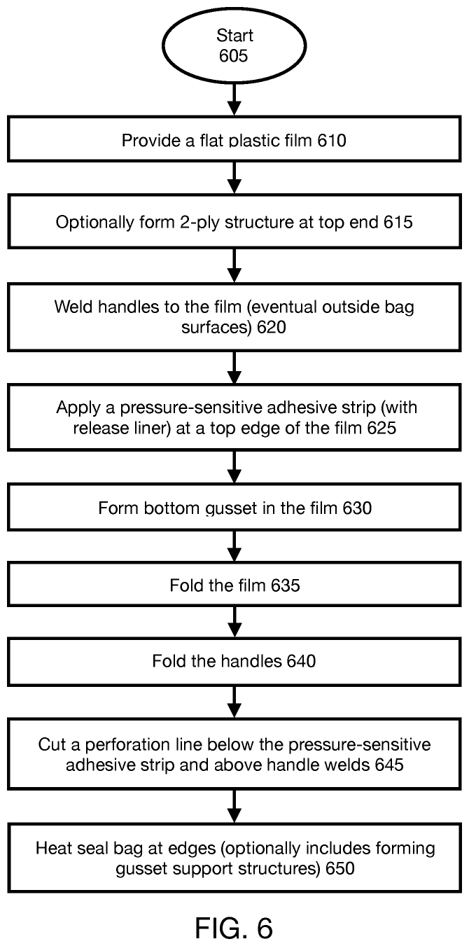

FIG. 6 is a flow diagram of a method for manufacturing a reusable tamper-evident bag, according to an embodiment of the invention. The process starts in step 605 and provides a flat plastic film in step 610. Step 610 could include, for instance, performing a bubble extrusion process, and slitting the bubble, as will be understood by persons skilled in the art.

In certain embodiments, for instance those described with reference to FIGS. 1C and 2C, the process forms a 2-ply structure at a top end in step 615. Step 615 could include, for example, folding the film.

Next, the process welds handles to the film (at eventual outside bag surfaces) in step 620, and applies a pressure-sensitive adhesive strip (with release liner) at a top edge of the film in step 625. Various options exist for the location of the pressure-sensitive adhesive strip, as described above. The process forms a bottom gusset in the film in step 630. The process then folds the film in step 635, temporarily folds the handles down in step 640, and cuts a perforation line below the pressure-sensitive adhesive strip and above handle welds in step 645. Folding step 635 aligns top (opening) edges of the bag (but not completely in a flap embodiment). The purpose of folding step 640 is to remove the handles from the cutting plane associated with step 645. The process heat seals the bag at the edges (e.g., at edges 100 to join sidewalls) in step 650. Step 650 may also include forming gusset support structures before sealing the bag at the sides.

Variations in the process illustrated in FIG. 6 and described above are possible. In one respect, the manufacturing sequence could be varied. For instance the adhesive application step 625 could be earlier or later in the flow.

The process in FIG. 6 could also be modified, for example, by providing a plastic bubble in step 610, and then forming two opposing gussets in step 615. One of the gussets could be slit to provide the 2-ply structure, and the other could be the bottom gusset.

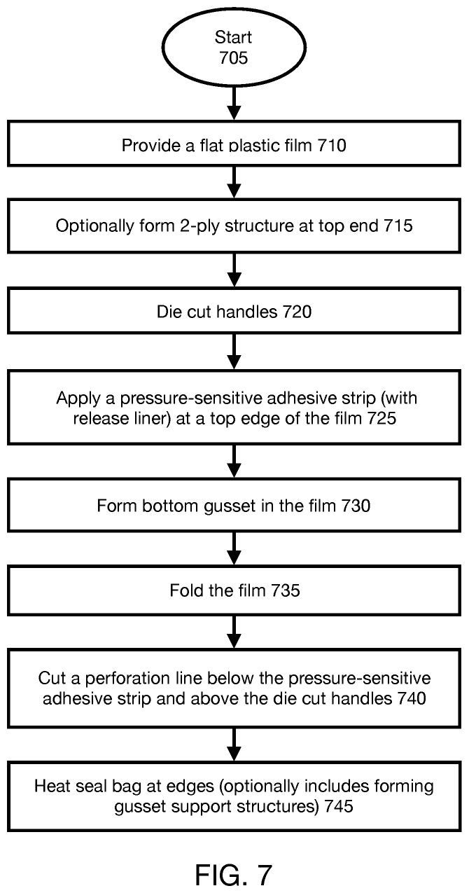

FIG. 7 is a flow diagram of a method for manufacturing a reusable tamper-evident bag, according to an embodiment of the invention. The process starts in step 705 and provides a flat plastic film in step 710. Step 710 could include, for instance, performing a bubble extrusion process, and slitting the bubble, as will be understood by persons skilled in the art.

In certain embodiments, for instance those described with reference to FIGS. 3C, and 4C, the process forms a 2-ply structure at a top end in step 715. Step 715 could include, for example, folding the film.

Next, the process die cuts handles in the film in step 720, and applies a pressure-sensitive adhesive strip (with release liner) at a top edge of the film in step 725. Various options exist for the location of the pressure-sensitive adhesive strip, as described above. The process forms a bottom gusset in the film in step 730. The process then folds the film in step 735, and cuts a perforation line below the pressure-sensitive adhesive strip and above the die cut handles in step 740. Folding step 735 aligns top (opening) edges of the bag (but not completely in a flap embodiment). The process heat seals the bag at the edges (e.g. at edges 100 to join sidewalls) in step 745. Step 745 may also include forming gusset support structures before sealing the bag at the sides.

Variations in the process illustrated in FIG. 7 and described above are possible. In one respect, the manufacturing sequence could be varied. For instance the adhesive application step 725 could be earlier or later in the flow. Moreover, if may be advantageous to die cut the handles after folding the film in step 735.

The process in FIG. 7 could also be modified, for example, by providing a plastic bubble in step 710, and then forming two opposing gussets in step 715. One of the gussets could be slit to provide the 2-ply structure at the bag opening, and the other could be the bottom gusset.

In the case of paper construction, the manufacturing process could vary from what is illustrated in FIGS. 6 and 7 and described above. For instance, such flow may involve cutting, folding, and gluing to achieve the same structure and arrangement of features illustrated in the various embodiments described herein.

### CONCLUSION

Those skilled in the art can readily recognize that numerous variations and substitutions may be made in the invention, its use and its configuration to achieve substantially the same results as achieved by the embodiments described herein. For example, features described with reference to different embodiments in this application can be combined in ways not expressly described. Accordingly, there is no intention to limit the invention to the disclosed exemplary forms. Many variations, modifications and alternative constructions fall within the scope and spirit of the disclosed invention.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. A method for manufacturing the tamper-evident bag, comprising the steps of:
a) providing a flat plastic film;
b) welding a plurality of handles to the film at a plurality of weld areas, the plurality of weld areas being the at least one handle feature;
c) applying the pressure-sensitive adhesive strip;
d) forming a bottom gusset;
e) folding the film;
f) folding the handles; and
g) cutting the perforation line.

15. The method for manufacturing the tamper-evident bag as in claim 14, further comprising, after the providing and before the welding, forming a 2-ply structure at a top end, the top end extending from below the plurality of weld areas to the opening.

16. A method for manufacturing the tamper-evident thermoplastic bag, comprising:
a) providing a flat plastic film;
b) die cutting a plurality of handles in the film, the plurality of handles being the at least one handle feature;
c) applying the pressure-sensitive adhesive strip;
d) forming a bottom gusset;
e) folding the film; and
f) cutting the perforation line;
wherein the method further comprises, after the providing and before the die cutting, forming a 2-ply structure at a top end, the top end extending from below the plurality of handles to the opening.

17. (canceled)
